(19) United States
(12) Patent Application Publication
(10) Pub. No.: US 2026/0054777 A1
(43) Pub. Date: Feb. 26, 2026

(54) Side Sill for a Passenger-Vehicle Body, Passenger-Vehicle Body, Passenger Vehicle, and Method

(71) Applicant: Bayerische Motoren Werke Aktiengesellschaft, Muenchen (DE)

(72) Inventors: Jan DANNEBERG, Muenchen (DE); Olaf KNOPP, Kumhausen (DE); Benjamin KOCH, Weilheim (DE); Stefan KUGELMANN, Muenchen (DE); Liudmila LAUER, Augsburg (DE); Juergen LESCHHORN, Geltendorf (DE); Marco PARISI, Muenchen (DE)

(21) Appl. No.: 19/100,188

(22) PCT Filed: Jul. 5, 2023
(86) PCT No.: PCT/EP2023/068551

§ 371 Date: Jan. 31, 2025

(30) Foreign Application Priority Data
Aug. 1, 2022 (DE) 10 2022 119 237.7

(51) Int. Cl. B62D 25/02; B62D 27/02; B62D 27/06

(52) U.S. Cl. CPC B62D 25/025; B62D 27/02; B62D 27/065

(57) ABSTRACT

A side sill for a body of a passenger vehicle includes a support element made of steel, and at least one insert part made of a light metal, which is directly bonded to the support element by the formation of at least one bonded seam and is surrounded, at least in part, on the outer peripheral side by the support element. As a result, when the side sill is in the fully manufactured state, the carrier element has an open region in which the insert part is arranged without an overlap with respect to the support element, wherein the bonded seam directly adjoins the open region.

### BACKGROUND AND SUMMARY

The invention relates to a side sill for a passenger-vehicle body. Furthermore, the invention relates to a passenger-vehicle body and a passenger vehicle. The invention also relates to a method for producing a side sill for a passenger-vehicle body.

DE 10 2010 051 783 A1 discloses a body for a passenger vehicle with a plurality of body components. DE 10 2010 051 785 A1 also discloses such a body for a motor vehicle. Furthermore, DE 10 2009 030 432 A1 discloses a hybrid assembly for a motor vehicle. Furthermore, DE 10 2006 058601 B4 describes a method for producing a hybrid assembly. In addition, WO 2012/159603 A1 discloses a side sill for a vehicle body.

The object of the present invention is to provide a side sill for a body of a passenger vehicle, a body for a passenger vehicle, a passenger vehicle, and a method so that the side sill can be produced in a particularly advantageous manner.

According to the invention, this object is achieved by a side sill, a body, a passenger vehicle and a method, in accordance with the independent claim(s). Advantageous embodiments of the invention are the subject of the dependent claims.

A first aspect of the invention relates to a side sill for a body of a passenger vehicle, also referred to as a passenger-vehicle body. Preferably, the body is a self-supporting body. The side sill has a direction of longitudinal extent, wherein the side sill extends at least substantially longitudinally along its direction of longitudinal extent. In the completely produced state of the passenger vehicle, the direction of longitudinal extent or the longitudinal extent of the side sill runs in the longitudinal direction of the vehicle, which is also referred to as the x-direction.

The side sill has a support element made of steel. In addition, the side sill comprises at least one insert part, which is formed from a light metal, in particular aluminum. In particular, this means that the insert part, also simply referred to as an insert, is formed, i.e., produced, from a light metal alloy, in particular an aluminum alloy, for example. The insert part is bonded directly to the support element, forming at least one bond seam. The bond seam is formed by an adhesive by means of which the insert part is bonded directly to the support element. In particular, this means that the bond seam or the adhesive is arranged between the insert part and the support element and the insert part is in direct contact with the support element. For example, the bond seam is also referred to as an adhesive bead or the bond seam is designed as an adhesive bead. The insert part is partially surrounded on the outer circumference, in particular only or exclusively, by the support element, whereby the support element has an open region in the completely produced state of the side sill, in particular in the completely produced state of the body and in particular in the completely produced state of the passenger vehicle. The open region is therefore an opening or the open region is also referred to as the opening of the support element. In the open region, the insert part is arranged without overlapping with the support element and this means that the insert part is not overlapped or covered by the support element in the open region, in particular when viewed from the outside and, in other words, it is intended that there is no overlapping or covering of the insert part by the support element in the open region.

Furthermore, it is provided in the side sill according to the invention that, in particular in the completely produced state of the side sill, in particular in the completely produced state of the body and in particular in the completely produced state of the passenger vehicle, the bond seam directly adjoins the open region in the circumferential direction of the side sill and thus of the support element and the insert part extending around the longitudinal direction of the side sill. This makes the bond seam accessible to heat or air, in particular via the open region, from which heat can be transferred to the bond seam, i.e., to the adhesive, whereby, for example, the bond seam, i.e., the adhesive, can be cured particularly advantageously and in particular completely in a method for producing the side sill.

In the aforementioned method, for example, the side sill is placed in an oven in which warm or heated air is conveyed, particularly in the form of circulating air. Since the support element now has the open region and the bond seam directly adjoins the open region, the warm or heated air can flow particularly well and in particular directly to at least part of the bond seam, so that heat can be transferred from the air to the bond seam in a particularly advantageous manner. As a result, the bond seam or the adhesive can be cured particularly well and in particular completely, so that the bond seam has a structural or load-bearing function when the side sill is completely produced, in particular to the effect that the support element and the insert part are firmly connected to one another by means of the bond seam, i.e., by means of the adhesive forming the bond seam.

The side sill according to the invention thus makes it possible to cure the bond seam advantageously and completely, so that, for example, the bond seam or the adhesive is taken into account in an analysis, in particular a numerical analysis, of an accident behavior of the side sill or an accident-related deformation of the side sill, in particular to the effect that the bond seam can, for example, absorb and/or transfer accident-related loads, and/or ensures at least temporary structural preservation of the side sill. Due to the fixed connection between the insert part and the support element realized by the bond seam, the insert part is a co-supporting reinforcement, in particular one that is resistant to brute force. In other words, the insert part is a reinforcing element by which the side sill is advantageously reinforced. This allows a particularly advantageous accident behavior of the side sill to be achieved. The insert part has a particularly high energy absorption capacity, so that, for example, accident energy can be advantageously dissipated by the support element, i.e., by accident-related deformation of the support element in the event of an accident, in particular by the fact that accident energy can be converted into deformation energy. In addition, the invention makes it possible to avoid cost-intensive joining techniques, for example when joining an outer paneling or a side frame of the side sill or with the side sill.

In order to be able to realize a particularly strong connection between the insert part and the support element without having to use costly joining techniques, it is provided in one embodiment of the invention that the insert part is riveted directly to the support element. For example, the insert part is riveted directly to the support element by means of at least one rivet. The rivet may penetrate the bond seam.

Alternatively or additionally, the insert part may be screwed directly to the support element, in particular by means of at least or exactly one screw, which can be designed, for example, as a spot-hole screw (SHS). Alternatively or additionally, for example, the insert part can be mechanically connected to the support element of at least or exactly one additional element.

Another embodiment is distinguished in that the insert part is designed as an extruded profile. This allows the costs of the side sill to be kept particularly low, meaning that the side sill can be produced particularly cost-effectively. In addition, a particularly high energy absorption capacity of the insert part can be realized in a cost-effective manner.

In order to be able to produce the side sill particularly cost-effectively, it is provided in a further embodiment of the invention that the support element has several support parts formed from the steel, which are formed separately from one another and connected to one another.

It has proven to be particularly advantageous if the support parts are welded together directly, in particular by spot welding. This allows the support parts to be joined together particularly cost-effectively and firmly, so that the side sill can be produced particularly cost-effectively.

Lastly, it has been shown to be particularly advantageous if the open region extends over an angular range of at least 30°, in particular at least 45° and in particular more than 45°, in particular at least and in particular more than 60°, in the circumferential direction of the side sill extending around the longitudinal direction of the side sill. As a result, the bond seam is particularly easily accessible to the aforementioned heat or air, whereby the bond seam can be cured particularly well and completely. This means that the side sill can be produced particularly cost-effectively.

A second aspect of the invention relates to a body for a passenger vehicle, preferably constructed as a self-supporting body and also referred to as a passenger-vehicle body, wherein the body according to the second aspect of the invention has at least one side sill, in particular according to the first aspect of the invention. The side sill has a support element formed from a steel and at least one insert part formed from a light metal, which is bonded directly to the support element with the formation of at least one bond seam and is partially surrounded on the outer circumference, in particular only, by the support element. As a result, in the fully produced state of the body, in particular of the passenger vehicle, the support element has an open region in which the insert part is arranged without overlapping with the support element, wherein the bond seam directly adjoins the open region in the circumferential direction of the side sill extending around the longitudinal direction of the side sill. As already explained with regard to the first aspect of the invention, this makes the bond seam particularly easily accessible to heat or heated air, whereby the bond seam can be easily and completely cured. Advantages and advantageous embodiments of the first aspect of the invention are to be regarded as advantages and advantageous embodiments of the second aspect of the invention and vice versa.

A third aspect of the invention relates to a passenger vehicle, also referred to simply as a vehicle, which has a body, in particular according to the second aspect of the invention. In the third aspect of the invention, the body has at least one side sill which has a support element formed from a steel and at least one insert part formed from a light metal. The insert part is bonded directly to the support element, forming at least one bond seam, and is partially surrounded on the outer circumference, in particular only, by a support element, whereby the support element has an open region in the completely produced state of the passenger vehicle, in which the insert part is arranged without overlapping with the support element. The bond seam directly adjoins the open region in the circumferential direction of the side sill extending around the longitudinal direction of the side sill. Advantages and advantageous embodiments of the first aspect and the second aspect of the invention are to be regarded as advantages and advantageous embodiments of the third aspect of the invention and vice versa.

A fourth aspect of the invention relates to a method for producing a side sill for a body of a passenger vehicle, which is designed in particular as a self-supporting body. The body is thus also referred to as a passenger-vehicle body. In the method, a structural unit is provided which has a first support part, formed from a steel, of a support element of the side sill and an insert part, formed from a light metal, which is bonded directly to the first support part, forming at least one bond seam, and is partially surrounded on the outer circumference, in particular only partially, by the first support part.

In the method, the structural unit is connected to a second carrier part of the support element formed from a steel only after the bond seam has completely cured, whereby, for example, the carrier parts are assembled and thereby form, for example, a hollow cross-section, in particular a closed one, in which, for example, the bond seam is or will be arranged.

The method according to the invention makes it possible, for example, for the structural unit to be produced, for example, by a supplier, so that, for example, the bond seam can cure, in particular completely, at the supplier, i.e., during a method for producing the structural unit carried out by the supplier. For example, the supplier delivers the produced assembly to a manufacturer, which is also referred to as an original equipment manufacturer or OEM and is, for example, a different manufacturer from the supplier or a different company from the supplier. The manufacturer (OEM) can then, for example, provide the aforementioned component and only connect it to the second carrier part after the bond seam has fully cured. It can thus be seen that the production of the structural unit can be carried out by the supplier and the joining of the structural unit to the second support element can be carried out by the manufacturer (OEM), whereby the side sill can be produced in a particularly time-and cost-effective manner. Furthermore, the side sill can be produced particularly quickly and cost-effectively by the manufacturer (OEM), as the bond seam is already cured and the manufacturer (OEM) no longer needs to cure the bond seam. Since the bond seam is (already) fully cured, the insert part is particularly firmly connected to the first carrier part, whereby the support element is advantageously reinforced by the insert part. Advantages and advantageous embodiments of the first aspect, the second aspect and the third aspect of the invention are to be regarded as advantages and advantageous embodiments of the fourth aspect of the invention and vice versa.

It is contemplated that by assembling the carrier parts, whereby the carrier parts form the rear cross-section, at least one longitudinal region of the insert part is completely surrounded by the support element in the circumferential direction of the side sill running around the longitudinal direction of the side sill, so that in particular the bond seam is overlapped or covered, in particular completely, by the support element, in particular when viewed from the outside.

Furthermore, it is preferably provided that, due to the fact that the insert part is only partially surrounded on the outer circumference by the first carrier part, the structural unit, before it is connected to the second carrier part, has an open region, or the previously described open region, in which the insert part is arranged without overlapping with the first carrier part, wherein the bond seam directly adjoins the open region of the structural unit in the circumferential direction of the side sill of the structural unit extending around the longitudinal direction of extension of the side sill. This allows the bond seam to be cured in a particularly advantageous manner, in particular before the structural unit is connected to the second support element, in particular at the supplier and/or by the method described above with regard to the side sill according to the invention. In order to be able to produce the side sill in a particularly advantageous and particularly cost-effective manner, it is provided in one embodiment of the invention that the structural unit is connected to the second carrier part by riveting the insert part directly to the second part. Alternatively or additionally, for example, the assembly unit is connected to the second carrier part by welding the first carrier part directly to the second carrier part, in particular by spot welding.

Further details of the invention can be found in the following description of preferred exemplary embodiments with the associated drawings.

### BRIEF DESCRIPTION OF THE DRAWINGS

FIG. 1 is a schematic cross-sectional view of a first embodiment of a side sill of a self-supporting body of a passenger vehicle;

FIG. 2 is a schematic cross-sectional view of a second embodiment of the side sill; and

FIG. 3 is a schematic cross-sectional view of a third embodiment of the side sill.

In the figures, like or functionally like elements are provided with the same reference signs.

### DETAILED DESCRIPTION OF THE DRAWINGS

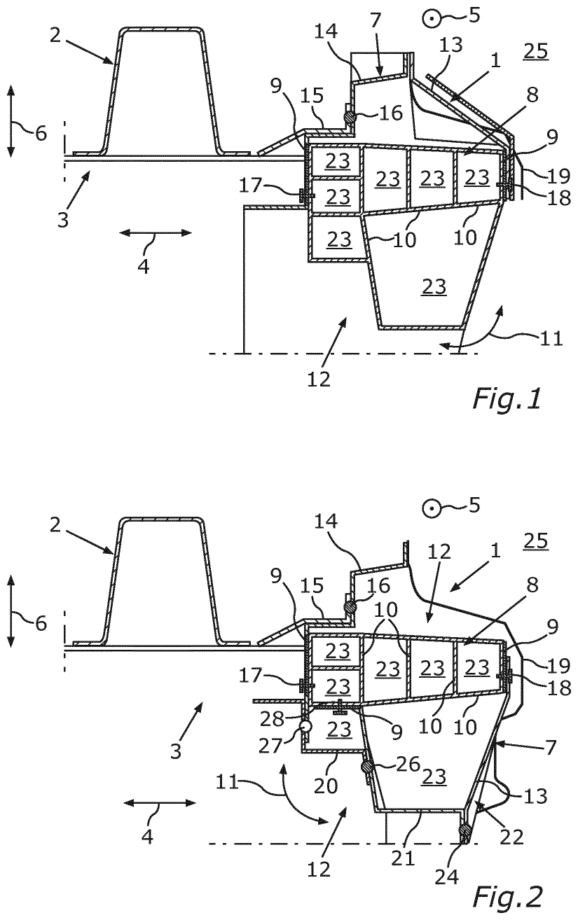

FIG. 1 shows a schematic cross-sectional view of a first embodiment of a side sill 1 of a self-supporting body 2 of a passenger vehicle, also known as a vehicle. The self-supporting body 2, also known as the body-in-white, comprises two side sills spaced apart in the transverse direction of the vehicle, namely the side sill 1 as a first of the side sills and a second side sill which is not recognizable in the figures. The body 2 also comprises a main floor 3, also known simply as the floor, by which the interior, also known as the passenger cell or passenger compartment, of the body and thus of the passenger vehicle, is bounded at the bottom in the vertical direction of the vehicle. The floor extends in the transverse direction of the vehicle between the aforementioned side sills. The transverse direction of the vehicle is illustrated in FIG. 1 by a double arrow 4, and the longitudinal direction of the vehicle is illustrated by a double arrow 5 and runs perpendicular to the image plane of FIG. 1. In addition, the vertical direction of the vehicle is illustrated by a double arrow 6.

The side sill 1 has a longitudinal extent that runs in the longitudinal direction of the vehicle, i.e., parallel to the longitudinal direction of the vehicle. The side sill 1 extends at least substantially longitudinally along the longitudinal direction. The side sill 1 comprises a support element 7, which is made of steel. This means that the support element 7 can be formed from exactly one, i.e., a single steel, or the support element 7 can be formed from several different steels. The side sill 1 also comprises an insert part 8, also known simply as an insert, which is made of a light metal, i.e., a light metal alloy. In the first embodiment shown in FIG. 1, the insert part 8 is made of aluminum, i.e., an aluminum alloy. Furthermore, the insert part 8 is an extruded profile. It can be seen from FIG. 1 that the insert part 8, in particular in its interior, has several hollow chambers 23, which are separated from one another by intermediate walls 10 of the insert part 8. Furthermore, the insert part 8 is designed as a single piece, i.e., formed from a single piece. In contrast, the support element 7, as will be explained in more detail below, is made up of several parts that are separate from each other and connected to each other, in particular built up. The insert part 8, which is formed as an extruded aluminum profile in the present case, is bonded directly to the support element 7, which is formed as a steel component, by forming at least or exactly two spaced-apart bond seams 9. This means that the bond seams 9 are formed by an adhesive, in particular by the same adhesive, wherein the insert part 8 is bonded directly to the support element 7 by means of the adhesive and thus by means of the respective bond seam 9.

Furthermore, it can be seen from FIG. 1 that the insert part 8 is only partially surrounded on the outer circumference by the support element 7, so that in the present case the support element 7 extends only partially around the insert part 8 in the circumferential direction of the side sill 1 extending around the longitudinal direction of the side sill 1 and thus of the support element 7 and the insert part 8. The circumferential direction of the side sill 1 is illustrated in FIG. 1 by a double arrow 11. Due to the fact that the insert part 8 is only partially surrounded by the support element 7 in the circumferential direction of the side sill 1 extending around the longitudinal direction of the side sill 1, the support element 7 has an open region 12 in the completely produced state of the side sill 1, the body 2 and the passenger vehicle as a whole shown in FIG. 1, in which the insert part 8 is not overlapped by the support element 7 towards the outside, i.e., in the direction of an environment 25 of the body 2 as a whole. This means that in the open region 12, the insert part 8 is arranged without overlapping with the support element 7. The respective bond seam 9 directly adjoins the open region 12 in the circumferential direction of the side sill 1 extending around the longitudinal direction of the side sill 1. This allows heat from the air surrounding the side sill 1 to be transferred particularly well to the respective bond seam 9, and thus to the respective adhesive forming the respective bond seam 9, whereby, for example, in a method for producing the side sill 1, the adhesive, which is initially liquid in particular, can be cured advantageously and in particular completely.

As can be seen from FIG. 1, the aforementioned parts of the support element 7 are support parts 13, 14 and 15, which are formed separately from one another and are connected to one another. For example, the support parts 14 and 15 are welded together, in particular directly, in particular by spot welding, so that, for example, the support parts 14 and 15 are welded together, in particular directly, forming at least one spot weld seam 16 and are thus connected to each other. Furthermore, in the first embodiment, it is provided that the insert part 8 is riveted directly to the carrier part 14 by means of at least one rivet 17, wherein the rivet 17 penetrates one of the bond seams 9, for example. Furthermore, in the first embodiment, it is provided that the insert part 8 is riveted directly to the carrier part 13 by means of at least one rivet 18, wherein the rivet 18 penetrates the other bond seam 9, for example. A further component 19 is also provided, which is formed separately from the insert part 8 and separately from the carrier parts 13, 14 and 15 and which can be formed, for example, as a paneling element and/or as an outer part of a side frame, in particular of the body 2. The structural element 19 can be a component of the support element 7, wherein, for example, the structural element 19 can be joined, in particular directly, to the carrier part 13. It is also contemplated that the component 19 is not part of the support element 7 and is joined, i.e., connected, to the support element 7, wherein the component 19 can, for example, be connected, in particular directly, to the carrier part 13. In this case, the insert part 8 is also not overlapped by the component 19 in the open region 12, so that heat from the aforementioned air can be transferred to the adhesive in a particularly advantageous manner for curing the adhesive.

It is quite preferable that in the completely produced state of the passenger vehicle as a whole, the insert part 8 is not overlapped by any component of the body 2 or of the passenger vehicle as a whole, in particular towards the outside and thus towards the surroundings 25. As a result, the side sill 1 can be produced particularly easily and cost-effectively, as the adhesive and thus the respective bond seam 9 can be cured completely and in a time-efficient manner. This ensures a particularly strong connection between the insert part 8 and the support element 7. It can be seen from FIG. 1 that the carrier part 13 of the support element 7, in particular the support element 7, is at least partially overlapped towards the outside, i.e., towards the environment 25, by the component 19 and thus covered. Thus, for example, the component 19 forms at least part of an outer skin of the body 2 or passenger vehicle, wherein the outer skin can be perceived visually and haptically by people in the vicinity 25.

In order to be able to cure the adhesive and thus the bond seams 9 advantageously and completely, it is provided, for example, that the open region 12 extends in the circumferential direction of the side sill 1 over an angular range which is at least 30°, in particular at least 45°. In the first embodiment, it is provided that the angular range is at least or exactly 90°.

FIG. 2 shows a schematic cross-sectional view of a second embodiment of the side sill 1. In the second embodiment, the support element 7 comprises the support parts 13, 14 and 15 and additional support parts 20 and 21, wherein the support parts 13, 14, 15, 20 and 21 of the support element 7 are formed separately from one another and, in particular, are directly connected to one another. In the second embodiment, the structural element 19 is provided, which can be a component of the support element 7 and thus a further carrier part of the support element 7, or else the structural element 19 is not a component of the support element 7. The structural element 19 can, for example, be connected to the carrier part 13, in particular directly. It is also contemplated that the structural element 19 is a component of the side sill 1, or the structural element 19 is not a component of the side sill 1 and is joined, i.e., connected, in particular directly, to the side sill 1, in particular to the carrier part 13 and in particular to the support element 7.

A method for producing the side sill 1 is described with reference to FIG. 2. In the method, a structural unit 22 is provided, which has the steel support parts 13 and 21 of the support element 7 of the side sill 1 and the insert part 8. The insert part 8 is bonded directly to the support element 7 with the formation of bond seams 9, in the present case in such a way that the support element is bonded directly to the support part 21 with the formation of a first of the bond seams 9 and directly to the support part 13 with the formation of a second bond seam 9. In addition, the carrier parts 13 and 21 are welded directly to each other, in particular by spot welding and thus, for example, by forming at least one spot weld seam 24.

The support parts 13 and 21, which are each bonded directly to the insert part 8, form a support part unit, of which the insert part 8 is only partially surrounded in the circumferential direction of the side sill 1 extending around the longitudinal direction of the side sill 1 and thus of the insert part 8 and the structural unit 22. As a result, the structural unit 22 in itself, i.e., viewed on its own, has an open region 12 in which the insert part 8 is arranged without overlapping with the carrier part unit, and is therefore not overlapped by the carrier part unit when viewed from the outside and thus from the surroundings 25. As a result, heat can be transferred particularly well from air surrounding the assembly unit 22, for example in an oven for curing the bond seams 9, to the bond seams 9, whereby the bond seams 9 can be cured advantageously and in particular completely.

Only after the bond seams 9 between the respective carrier part 13, 21 and the insert part 8 have completely cured is the structural unit 22 connected to the carrier parts 14 and 20, in particular directly, in the present case by the carrier part 21 being welded directly to the carrier part 20 and the carrier part 14 being welded directly to the carrier part 15. The carrier part 14 is welded directly to the carrier part 15 specifically by spot welding, forming a spot weld seam 16, and the carrier part 21 is welded directly to the carrier part 20 in particular by spot welding, forming a spot weld seam 26. In addition, the carrier part 14 is welded directly to the carrier part 20 in particular by spot welding, with the formation of a spot weld seam 27. Furthermore, in the second embodiment, it is provided that the insert part 8 is riveted directly to the carrier part 14, namely by means of at least one rivet 17. Alternatively or additionally, it is possible that the insert part 8 is screwed directly to the carrier part 14, namely by means of at least one screw such as a flow drilling screw. It is also possible for the insert part 8 to be mechanically connected directly to the carrier part 14 by means of at least one additional element, which may be the rivet 17 or the aforementioned screw, for example.

For example, the component 19 is connected, in particular directly, to the carrier part 14, in particular welded. Alternatively or additionally, the component 19 can be connected, in particular directly, to the carrier part 13, in particular welded. Furthermore, it is provided in the second embodiment that, for example, the insert part 8 is riveted directly to the carrier part 21 by means of a rivet 28, wherein, for example, the rivet 28 penetrates a first of the bond seams 9 and/or the rivet 18 penetrates a second of the adhesive rivets 9.

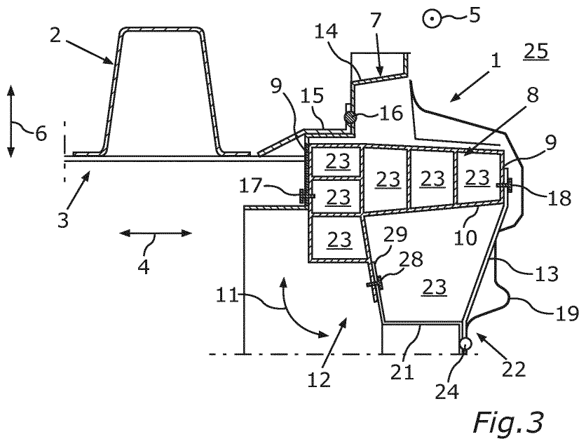

Finally, FIG. 3 shows a schematic cross-sectional view of a third embodiment of the side sill 1. The third embodiment of the side sill 1 is produced, for example, using the method explained with reference to the second embodiment. In the third embodiment, the carrier part 21 is riveted directly to the insert part 8 by means of a rivet 28. The assembly unit 22 comprises the insert part 8 and the carrier parts 13 and 21, wherein, for example, the bond seam 9 on the right in FIG. 3 directly adjoins the open region 12 of the assembly unit 22 in the circumferential direction of the side sill 1. This allows heat to be transferred particularly well from the air to the, in FIG. 3, right-hand bond seam 9, whereby the, in FIG. 3, right-hand bond seam 9 can be cured advantageously and completely. After the bond seam 9 on the right in FIG. 3 has cured, the assembly unit 22 is connected to the carrier part 14, in particular directly, for example by riveting the insert part 8 directly to the carrier part 14 by means of the rivet 17. In addition, for example, the carrier part 15 is welded directly to the carrier part 15, in particular by spot welding and thus with formation of a spot weld seam 16. It is also conceivable that the carrier part 21 is or is bonded directly to the carrier part 21 by means of a bond seam 29, i.e., by forming the bond seam 29. The bond seam 29 is formed by a previously mentioned adhesive, by means of which the carrier part 21 is bonded directly to the insert part 8. The rivet 28, for example, penetrates the bond seam 29.

Since in the second embodiment the structural unit 22 is connected, in particular directly, to the carrier part 20, in the present case for example by the carrier part 21 being connected, in particular directly, to the carrier part 20, in particular welded, the carrier parts 21 and 20 form or delimit a hollow cross-section 30, for example closed or open, in which the bond seam 9 on the left in FIG. 2 is or will be arranged. Furthermore, since the component 19, for example belonging to the side sill 1, in particular to the support element 7, is connected in the carrier part 14 and/or the carrier part 14, the component 19 and the carrier part 14, for example, delimit a second hollow cross-section 31, in particular an open or closed one, in which the bond seam 9 on the right in FIG. 2 is or will be arranged. Since in the third embodiment the component 19 is connected, in particular directly, in particular welded, to the carrier part 13 and/or the carrier part 14, the component 19 and the carrier part 14, for example, delimit a hollow cross-section 30 in which the bond seam 9 on the right in FIG. 3 is or will be arranged. The bond seam 29 can cure advantageously, for example, as it is very easily accessible to the heat or the aforementioned air and thus for heat transfer from the air to the bond seam 29.

### LIST OF REFERENCE SIGNS

1 side sill
2 body
3 main floor
4 double arrow
5 double arrow
6 double arrow
7 support element
8 insert part
9 bond seam
10 intermediate wall
11 double arrow
12 open region
13 support part
14 support part
15 support part
16 spot weld seam
17 rivet
18 rivet
19 component
20 support part
21 support part
22 component
23 hollow chamber
24 spot-welded seam
25 environment
26 spot-welded seam
27 spot-welded seam
28 rivet
29 bond seam
30 hollow cross-section
31 hollow cross-section

1.-10. (canceled)

11. A side sill for a body of a passenger vehicle, comprising:
a support element formed of a steel; and
at least one insert part formed of a light metal,
at least one bond seam formed by bonding the insert part directly to the support element, wherein
the insert part is partially surrounded on an outer circumference by the support element, and
the support element, in a completely produced state of the side sill, has an open region in which the insert part is arranged without overlapping with the support element, the bond seam directly adjoining the open region.

12. The side sill according to claim 11, wherein
the insert part is riveted and/or screwed directly to the support element and/or is mechanically connected via at least or exactly one additional element.

13. The side sill according to claim 11, wherein
the insert part is an extruded insert part profile.

14. The side sill according to claim 11, wherein
the support element comprises a plurality of support parts formed from the steel, formed separately from one another, and connected to one another.

15. The side sill according to claim 14, wherein
the support parts are welded directly to one another.

16. The side sill according to claim 11, wherein
the open region extends in a circumferential direction of the side sill over an angular range of at least 30 degrees.

17. The side sill according to claim 16, wherein
the open region extends in a circumferential direction of the side sill over an angular range of at least 45 degrees.

18. A body for a passenger vehicle, comprising:
at least one side sill comprising a support element formed of a steel and at least one insert part formed of a light metal, which insert part is bonded directly to the support element with the formation of at least one bond seam and is partially surrounded on an outer circumference by the support element,
wherein the support element in a completely produced state of the body has an open region in which the insert part is arranged without overlapping the support element, and
wherein the bond seam directly adjoins the open region.

19. A passenger car comprising a body according to claim 16.

20. A method for producing a side sill for a body of a passenger vehicle, the method comprising the steps of:
providing a structural unit comprising at least one first support part formed of a steel, a support element of the side sill, and an insert part formed of a light metal, wherein the insert part is bonded directly to the first support part forming at least one bond seam and is partially surrounded on an outer circumference by the first support part; and
connecting the structural unit to a second support part, formed of a steel, of the support element only after the bond seam has completely cured.

21. The method according to claim 20, wherein the structural unit is connected to the second support part by:
the insert part being riveted directly to the second support part; and/or
the first support part being welded directly to the second support part.
